(19) United States
(12) Patent Application Publication
(10) Pub. No.: US 2022/0101006 A1
(43) Pub. Date: Mar. 31, 2022

(54) DEVICE FOR COMPENSATING MOVEMENT OF AN EVENT-DRIVEN SENSOR AND ASSOCIATED OBSERVATION SYSTEM AND METHOD

(71) Applicant: Commissariat à l'énergie atomique et aux énergies alternatives, Paris (FR)

(72) Inventors: Maxence Bouvier, Grenoble (FR); Alexandre Valentian, Grenoble (FR)

(73) Assignee: Commissariat à l'énergie atomique et aux énergies alternatives, Paris (FR)

(21) Appl. No.: 17/449,304

(22) Filed: Sep. 29, 2021

(30) Foreign Application Priority Data
Sep. 30, 2020 (FR) 20 09966

(51) Int. Cl. G06K 9/00; G06K 9/62; G06N 3/04

(52) U.S. Cl. CPC G06K 9/00718; G06N 3/04; G06K 9/0063; G06K 9/6202

(57) ABSTRACT

The invention relates to a device for compensating for the movement of an event-driven sensor (12) in an initial event stream generated by observing an environment, the event-driven sensor (12) generating information representing each initial event in a first space in the form of a pixel address field (20) and a time of generation field of the initial event, the device (16) comprising:

a projection unit (34) projecting the initial stream from the first space to a second space, the projected stream being projected events associated with initial events, and generating information representing each projected event in the second space in the form of a pixel address field (20), a characteristic moment field and a value field relating to the set of initial events, and

a compensation unit (36) receiving measurements of the movement of the event-driven sensor (12) and applying a compensation technique to the projected flow.

This patent application claims the benefit of document FR 20 09966 filed on Sep. 30, 2020 which is hereby incorporated by reference.

### FIELD OF THE INVENTION

The present invention relates to a device for compensating for the movement of an event-driven sensor in an event stream generated during an observation of an environment. The present invention also relates to an environmental observation system comprising the above compensation device. The present invention also relates to a corresponding compensation method.

### BACKGROUND OF THE INVENTION

In the field of embedded video surveillance, one difficulty is to analyse a large volume of images within which many images are irrelevant. This is because it requires significant hardware resources and therefore energy consumption, which is incompatible with the constraints of an embedded system, namely limited weight, size and power.

One promising way to address this issue is to use an event-driven sensor.

A DVS sensor or an ATIS sensor are two examples of such a sensor. The abbreviation DVS stands for Dynamic Vision Sensor, while the acronym ATIS stands for Asynchronous Time-based Image Sensor.

Traditional imagers provide images, i.e. a succession of matrices that encode the light intensity values measured by a grid of pixels at a regular frequency. Instead, an event-driven sensor generates an asynchronous and sparse event stream since a pixel generates an event only when an intensity gradient on the pixel exceeds a certain threshold.

An event-driven sensor therefore ensures that no data is sent out when nothing is happening in front of the event-driven sensor, which greatly limits the amount of data to be processed.

In addition, due to the asynchronous operation, such sensors also allow for a high dynamic range and acquisition frequency. In particular, for some sensors, the rate of events that can be generated can be as high as 10 GeV/s (GeV/s stands for “Giga Events per second” and represents the number of billions of events per second contained in an event stream).

However, such a high acquisition frequency in turn requires a lot of computing power to process the events in the event stream.

This difficulty is compounded by the fact that the computational load is inherently unpredictable, making it difficult to process the data with maximum efficiency (which is often achieved when processing is carried out with maximum load).

In addition, due to its intrinsic noise, an event-driven sensor generates spurious events, which further increases the computational load unnecessarily.

In addition, when the event-driven sensor moves, individual pixels spike even when a stationary object is present. This results in spatial redundancy, again involving many unnecessary calculations.

### SUMMARY OF THE INVENTION

There is therefore a need for a device to compensate for faults introduced by an event-driven sensor in an event stream generated during an observation of an environment that reduces the computational capacity required to enable physical implementation in an embedded system while retaining the useful information captured by the event-driven sensor.

For this purpose, the description describes a device for compensating the movement of an event-driven sensor in an event stream generated within a time interval, called the initial event stream, the initial event stream being generated by the event-driven sensor upon observation of an environment in the time interval, the event-driven sensor comprising pixels and a reader unit, each pixel being adapted to generate an initial event of the initial event stream, the reader unit being adapted to generate information representing each initial event in the form of a first plurality of information fields in a first space, the first plurality of information fields comprising a first information field corresponding to the address of the pixel that generated the initial event and a second information field corresponding to the time of generation of the event by the pixel that generated the initial event. The compensation device comprises a projection unit, the projection unit being adapted to project the initial event stream from the first space to a second space using a projection function to obtain a projected event stream, the projected event stream being a set of projected events, each projected event being associated with a set of initial events from a respective pixel group, the projection unit being adapted to generate information representing each projected event as a plurality of information fields in the second space, the second plurality of information fields comprising a first information field corresponding to the address of a pixel associated with the projected event, a second information field being a moment characteristic of the projected event and a third information field being a value relating to the set of initial events with which the projected event is associated. The compensation device further comprising a compensation unit, the compensation unit being adapted to receive measurements of the movement of the event-driven sensor during the time interval, and adapted to apply a compensation technique to the projected event stream based on the received measurements to obtain a compensated event stream in the time interval.

According to particular embodiments, the compensation device has one or more of the following features taken in isolation or in any combination that is technically possible:
the projection unit projects the initial event stream into the second space so that a ratio of the number of initial events in the initial event stream to the number of projected events in the projected event stream is strictly superior to 1.
the projection unit is a device implementing a neural network.
the neural network has a single hidden layer.
the projection function is a convolutional filter with a plurality of convolution kernels, each kernel being associated with a channel, the neural network thus being a spiking convolutional neural network, and wherein, for each projected event, the third information field comprises the channel identifier of the convolution kernel to which said projected event belongs.
each convolution kernel is a set of receptive fields with an identical pattern, two successive receptive fields being separated by a stride, the number of convolution kernels, the stride and the size of the receptive fields being chosen so that the ratio of the number of projected events in the projected event stream to the number of initial events in the initial event stream is between 1.5 and 100.
for each projected event, the moment characteristic of the projected event is chosen from the list consisting of a moment obtained by applying a function to the set of moments at which a neuron of the neural network has received an activation, and a moment obtained by applying a function to at least one moment when an initial event was generated from the set of initial events with which the projected event is associated.
the projection unit and the compensation unit are implemented on the same integrated circuit.
each plurality of information fields comprises an additional information field, the additional information field being the sign of the intensity gradient measured by the pixel at the time the spike was generated, the light intensity value at the time the spike was generated or the intensity gradient value measured by the pixel at the time the spike was generated.
the compensation technique comprises the application of at least one operation selected from a correction of the distortion introduced by a collection optic of the event-driven sensor, a multiplication of the stream of events enriched by a rotation matrix corresponding to the rotational movements of the event-driven sensor, and an addition to the stream of events enriched of a translation matrix corresponding to the translational movements of the event-driven sensor.

The description also describes a system for observing an environment, the observation system comprising an event-driven sensor generating an event stream upon observation of the environment, the event-driven sensor having pixels and a reader unit, each pixel being adapted to generate an initial event of the initial event stream, the reader unit being adapted to generate information representing each initial event as a plurality of information fields in a first space, the first plurality of information fields comprising a first information field corresponding to the address of the pixel that generated the initial event and a second information field corresponding to the moment when the event was generated by the pixel that generated the initial event. The observation system further comprises a measuring unit for measuring the movement of the event-driven sensor during a time interval, and a compensation device as described above.

According to particular embodiments, the observation system has one or more of the following features taken in isolation or in any combination that is technically possible:
the observation system further comprises a determination unit, the determination unit being adapted to determine, for each projected event of the compensated event stream, the mobile or stationary nature of an object associated with the projected event, the object being the object in the environment by the event-driven sensor that caused the generating of the set of events associated with the projected event, and a modification unit, the modification unit being adapted to modify the projection function according to whether the object is mobile or fixed.
the event-driven sensor and the compensation device are part of a single component comprising a stack of at least three layers, the first layer of the stack comprising the event-driven sensor, the second layer of the stack comprising the projection unit and the third layer comprising the compensation unit.
the compensation unit is implemented on a further component, the component and the compensation unit being mounted on a substrate comprising electrical connections.
the substrate is an interposer.

The present description also provides a method of compensating for the movement of an event-driven sensor in an event stream generated within a time interval, called the initial event stream, the initial event stream being generated by the event-driven sensor upon observation of an environment in the time interval, the event-driven sensor comprising pixels and a reader unit, each pixel being adapted to generate an initial event of the initial event stream, the reader unit being adapted to generate information representing each initial event in the form of a first plurality of information fields in a first space, the first plurality of information fields comprising a first information field corresponding to the address of the pixel that generated the initial event and a second information field corresponding to the time of generation of the event by the pixel that generated the initial event, the compensation method being implemented by a device compensating for the movement of the event-driven sensor in the generated event stream within a time interval and comprising a step of projecting the initial event stream from the first space to a second space by using a projection function to obtain a projected event stream, the projected event stream being a set of projected events, each projected event being associated with a set of initial events from a respective group of pixels, the projection step comprising generating the information representing each projected event as a plurality of information fields in the second space, the second plurality of information fields comprising a first information field corresponding to the address of a pixel associated with the projected event, a second information field being a characteristic time of the projected event and a third information field being a value relating to the set of initial events with which the projected event is associated. The compensation method further comprising a compensation step comprising applying a compensation technique to the projected event stream based on received measurements of the event-driven sensor movement during the time interval to obtain a compensated event stream in the time interval.

### BRIEF DESCRIPTION OF THE DRAWINGS

Characteristics and advantages of the invention will become apparent upon reading the following description, given only as a nonlimiting example, referring to the attached drawings, in which:

FIG. 1 is a schematic view of an example observation system,

FIG. 2 is a depiction of an example neural network used by the observation system of FIG. 1,

FIG. 3 is a schematic depiction of the operation of part of the neural network of FIG. 2,

FIG. 4 is a graphical depiction of an initial event stream and a projected event stream, the projected event stream being obtained by simulation for a first set of parameters for the neural network of FIG. 2,

FIG. 5 is a graphical depiction of an initial event stream and a projected event stream, the projected event stream being obtained by simulation for a second set of parameters for the neural network of FIG. 2,

FIG. 6 is a graphical depiction of an initial event stream and a projected event stream, the projected event stream being obtained by simulation for a third set of parameters for the neural network of FIG. 2,

FIG. 7 is a graphical depiction of an initial event stream and a projected event stream, the projected event stream being obtained by simulation for a fourth set of parameters for the neural network of FIG. 2,

FIG. 8 is a graphical depiction of a projected event stream and a compensated event stream, the compensated event stream being obtained by simulation from the depicted projected event stream,

FIG. 9 is a schematic depiction of an example physical embodiment of an observation system according to FIG. 1,

FIG. 10 is a schematic depiction of a further example physical embodiment of an observation system according to FIG. 1,

FIG. 11 is a schematic depiction of a further example physical embodiment of an observation system according to FIG. 1, and

FIG. 12 is a schematic view of an example observation system.

### DETAILED DESCRIPTION OF THE PREFERRED EMBODIMENTS

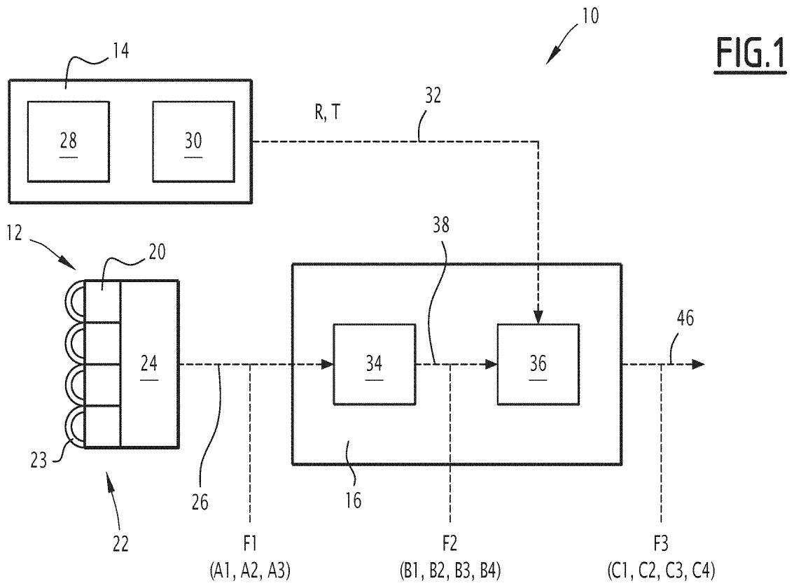

An observation system 10 is schematically depicted in FIG. 1.

The depiction is schematic insofar as it is a functional block diagram allowing a good understanding of the operation of the observation system 10.

The observation system 10 is suitable for observing an environment. The observation system 10 comprises an event-driven sensor 12, a measuring unit 14 and a compensation device 16.

The event-driven sensor 12 is suitable for generating an event stream F1 by observing the environment in a time interval, called the observation time interval.

In the following, the event stream F1 generated in the observation time interval is referred to as the initial event stream 1.

The initial event stream F1 is a generally sparse stream.

As mentioned earlier, the generated stream is asynchronous, which allows the event-driven sensor 12 to operate at a high frequency.

More specifically, the event-driven sensor 12 comprises a set of pixels 20 arranged in a pixel array 22, a collection optic 23 and a reading system 24.

Each pixel 20 is capable of generating an event in the form of a pulse. Such a pulse is often referred to as a “spike”.

To generate an event, each pixel 20 continuously measures the incident light intensity with a photodiode and compares the relative difference between the light intensity I_{curr} measured at an instant t and the light intensity Iₚᵣₑᵥ measured at the immediately preceding instant to a contrast threshold Cₜₕ according to the following formula:

$$\frac{{I}_{c u r r} - {I}_{p r e v}}{{I}_{p r e v}} \geq {C}_{t h}$$

When the above condition is met, the pixel 20 generates a spike.

Alternatively, other conditions can be used.

For example, the condition is that the measured intensity is greater than or equal to a threshold or that the time taken to reach a predetermined intensity is less than or equal to a threshold.

However, in each case, spike generation only takes place if the condition is met to ensure high-speed operation of the event-driven sensor 12.

Such a spike is often expressed according to the AER protocol. The acronym AER stands for Address Event Representation.

However, other representations such as analogue representations (e.g. by emitting a plurality of spikes to encode information) are also possible.

The collection optic 23 collects the incident light and guides it to the pixel array 22.

According to the example described, the collection optics 23 is an array of microlenses with each microlens associated with a single pixel 20.

For example, each microlens of the collection optic 23 is a hypergonal optic.

Such a lens is more often referred to as a fisheye lens in reference to its very large field of view.

This very large field of view means that the collection optic 23 introduces a great deal of distortion which must be compensated for.

Other geometric aberrations can also be introduced by the collection optics 23 such as vignetting.

The reading system 24 is an electronic circuitry generating information representing each initial event as a first plurality of information fields in a first space.

With such a format, for the example described, the spike is a triplet with three elements A1, A2 and A3.

The first information field A1 is the address of the pixel 20 that generated the spike.

The address of the pixel 20 is, for example, encoded by giving the row number and column number of the pixel array 22 where the pixel 20 is located.

Alternatively, a code of the type y*xmax+x or x*ymax+y can be used. In the above formula, x is the column number of pixel 20, y is the row number of pixel 20, xmax is the number of columns and ymax is the number of rows of the pixel matrix 22.

The second information field A2 is the instant when the spike was generated by the pixel 20 that generated the spike.

This implies that the event-driven sensor 12 is able to time-stamp spiking accurately enough to facilitate further processing of the initial event stream F1.

The third information field A3 is a value related to the spike.

In the following, as an example, the third information field A3 is the polarity of the spike.

The polarity of a spike is defined as the sign of the intensity gradient measured by pixel 20 at the time the spike is generated.

In other embodiments, the third information field A3 is the light intensity value at the time of spike generation, the observed depth if the event-driven sensor 12 is intended to measure depth, or the precise value of the measured intensity gradient.

Alternatively, the plurality of information fields in the first space comprises only the first information field A1 and the second information field A2.

The reading system 24 is suitable for routing the initial event stream F1 to the compensation device 16. This is symbolically depicted by the arrow 26 in FIG. 1.

As also visible in FIG. 1 below arrow 26, the output of the event-driven sensor 12 is the initial event stream F1, each event of which is a spike characterised by a triplet (A1, A2, A3).

The unit of measurement 14 is a unit of measurement of movement.

The measuring unit 14 is suitable for measuring the movement of the event-driven sensor 12.

According to the proposed example, the measurement unit 14 is an inertial measurement unit.

Such an inertial measurement unit is sometimes referred to as an IMU for short.

The measuring unit 14 thus contains gyros 28 and accelerometers 30 for measuring the rotational and translational movements of the event-driven sensor 12.

Depending on the case, the output data of the motion measurement unit 14 may be raw or integrated data.

For example, the integrated data is expressed as a rotation matrix R corresponding to the rotational movements of the event-driven sensor 12 or a translation matrix T corresponding to the translational movements of the event-driven sensor 12.

Alternatively, the rotation data is provided using a quaternion, which is typically a four-valued vector with one normalised value, the other values characterising the rotation in space.

The compensation device 16 is a device for compensating the movements of the event-driven sensor 12 in the initial event stream F1.

In this sense, the compensation device 16 is a device configured to implement a method of compensating for the movement of the event-driven sensor 12 in the initial event stream F1.

The compensation device 16 in FIG. 1 has a projection unit 34 and a compensation unit 36.

The projection unit 34 is adapted to project the initial event stream F1 from the first space to a second space to obtain a projected event stream F2.

In this sense, the projection unit 34 is configured to implement a step of the compensation process which is a step of projecting the initial event stream F1 onto the second space.

In this case, to implement such a step, the projection unit 34 uses a projection function to decrease the storage size of the event stream.

For this purpose, the projected event stream F2 is a set of projected events where each projected event is associated with a set of initial events from a respective pixel group.

The projection unit 34 is adapted to generate information representing each projected event as a second plurality of information fields in the second space.

In the example shown in FIG. 1, the second plurality of information fields comprises four information fields B1, B2, B3 and B4.

The first information field B1 corresponds to the address of a pixel 20 associated with the projected event.

The second information field B2 is a moment characteristic of the projected event.

Examples of characteristic moments are given below.

The third information field B3 is a value relating to an event in the set of initial events with which the projected event is associated.

According to the described example, the third information field B3 is the polarity of a spike, whereby other values proposed for the third information field A3 can also be used.

The fourth information field B4 is a value relating to the set of initial events with which the projected event is associated.

Thus, in the example shown in FIG. 1, a projected event is characterised by a quadruplet B1, B2, B3 and B4.

Alternatively, the plurality of information fields in the second space comprises only the first information field B1, the second information field B2, and the fourth information field B4.

The projection unit 34 is thus able to create projected events which are events that can be considered enriched events.

Each enriched event replaces a set of events.

According to the described example, with respect to an event of the initial event stream F1, an enriched event comprises the same information as the triplet, namely the first elements A1 and B1 which give address information, the second elements A2 and B2 which give time information, and the third elements A3 and B3 which give polarity information.

Nevertheless, the projected event comprises additional information (fourth element B4) which is a value related to the set of events that the spike replaces. The projected event is therefore an enriched event since the event includes information about spikes generated by other pixels.

As an example of a value related to the event set that the spike replaces, one can consider the number of events in the event set, the number of pixels that generated the event set or the addresses of the pixels in the event set.

A value encoding an observable pattern in the event set or a histogram relating to the event set could also be considered for the fourth information field B4.

According to the particular example corresponding to the special case of FIG. 1, the projection unit 34 applies a convolutional filter with several convolution kernels to the initial event stream F1.

Each convolution kernel is associated with a respective channel.

In the example described, for each enriched event, the fourth information field B4 is the identifier of the convolution kernel channel to which said event belongs.

Alternatively or additionally, the fourth information field B4 comprises further data.

The filter can be implemented by any type of mathematical processing.

For example, the filter is a set of convolution operations performed by successive integrations.

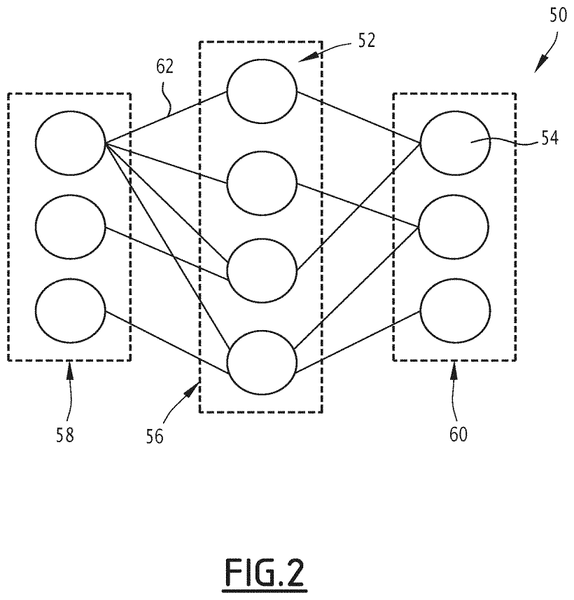

Alternatively, as shown in FIG. 2, the example filter is a neural network 50.

The neural network 50 described is a network comprising an ordered succession of layers 52 of neurons 54, each of which takes its inputs from the outputs of the preceding layer 52.

Specifically, each layer 52 comprises neurons 54 taking their inputs from the outputs of the neurons 54 of the previous layer 52.

In the case of FIG. 2, the neural network 50 described is a network with a single hidden layer of neurons 56.

The neural network 50 described is a network with a single hidden layer of neurons 56. This means that the neural network 50 has an input layer 56 followed by the hidden neural layer 58, followed by an output layer 60.

Each layer 52 is connected by a plurality of synapses 62. A synaptic weight is associated with each synapse 62. It is a real number, which takes on both positive and negative values. For each layer 52, the input of a neuron 54 is the weighted sum of the outputs of the neurons 54 of the previous layer 52, the weighting being done by the synaptic weights.

It should also be noted that the hidden layer 56 is not a fully connected layer to simplify the computational load associated with the neural network 50.

A fully connected layer of neurons 52 is one in which the neurons in the layer are each connected to all the neurons in the previous layer.

This type of layer 52 is often referred to as a “fully connected” layer.

In this case, the neural network 50 is a spike neural network.

A spike neural network is often referred to as a SNN.

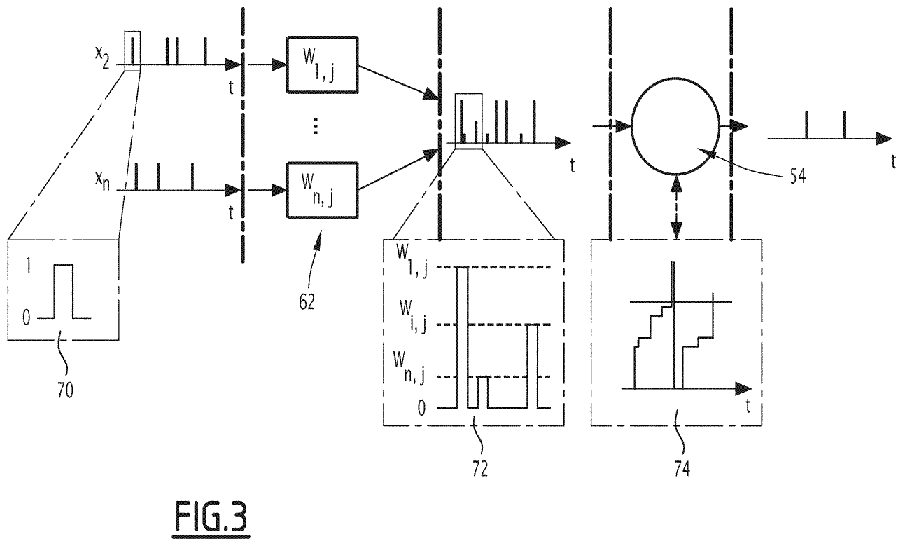

Thus, the spiking of the neural network 50 can be described with reference to FIG. 3.

A synapse 62 is considered to connect a neuron 54 located before the synapse 62 (the neuron 54 is a pre-synaptic neuron) to a neuron 54 located after the synapse 62 (the neuron 54 is then a post-synaptic neuron).

When such a synapse 62 receives a spike (see box 70 in FIG. 3), the synapse 62 emits a postsynaptic potential to stimulate the postsynaptic neuron 54.

Specifically, synapse 62 performs a multiplication between the weight and the input activation to obtain the postsynaptic potential (see inset 72 in FIG. 3). The input activation is the output signal sent by the pre-synaptic neuron 54.

It should be noted that, as spikes and weights are signed, so is the postsynaptic potential. For example, if a negatively polarised spike arrives at a positively weighted synapse 62 with a positive coefficient wᵢ, then the postsynaptic potential is negative and equal to −wᵢ.

In addition, the stimulation sent from the synapse 62 is a stimulation of a part of the post-synaptic neuron 54 called the membrane, which has a potential.

Referring to box 74 in FIG. 3, the post-synaptic neuron 54 then adds the post-synaptic potential to its membrane potential, compares the resulting membrane potential to a threshold S and emits an output spike when the membrane potential exceeds the threshold S.

In some cases, the post-synaptic neuron also adds bias weights to the membrane potential.

Because the filter is convolutional, the neural network 50 is a convolutional neural network.

A convolutional neural network is called a CNN for short.

In a convolutional neural network, each neuron has exactly the same connection pattern as its neighbouring neurons, but at different input positions. The connection pattern is called a convolution kernel.

A convolution kernel is a set of receptive fields with an identical pattern that will be repeated over the pixel matrix 22.

In this example, the convolution kernels are intended to detect oriented edges in the sense that the edges correspond to an abrupt change in polarity on either side of the edge.

According to the example described, each receptive field has a square shape.

Alternatively, each receptive field has a cross or line shape, but nothing prevents the use of a different pattern.

Furthermore, the kernel correlation coefficients (i.e. the weights) are binary weights in the proposed example.

However, other types of weights such as floating point weights are possible.

According to the example described, each receptive field has a square shape.

Alternatively, each receptive field has a cross or line shape.

Such a spiking convolutional neural network is characterised by several parameters which are the number of kernels per neuron 54, the size of the receptive field, the voltage threshold, the spacing between receptive fields, the precision of the weight, the refractory period, the type of leakage and the leakage rate.

Other parameters can also be considered, depending on the behaviour of the synapses. For example, some synapses use synaptic delays to measure time. The value of the synaptic delays is then a parameter characterising the spiking convolutional neuron network.

The number of kernels per neuron 54 is denoted Nₖ.

Alternatively, neural networks may be envisaged in which the number of kernels per neuron 54 varies based on the neuron 54 considered.

The size of the receptive field is denoted W_{RF} and is expressed in pixels.

The voltage threshold V_{S} is the value to which the membrane potential of neuron 54 is compared after each spike is received. If the membrane potential is above the voltage threshold V_{S} the neuron 54 emits a spike.

The spacing between receptive fields is denoted s in reference to the term “stride”.

The stride s is measured between two receptive field centres.

As the stride s affects the size of the coded data, the stride s is often expressed as a whole number of pixels.

Alternatively, the stride s can be coded as interneuron distance. This is particularly relevant when the neuron in question receives activations from an earlier layer.

The N_{b} weight precision is the bit precision of the synaptic weight values.

Since the more precise a weight is, the more memory space the weight will require, it can be considered that the parameter of the precision of the weight N_{b} is related to the demand on the hardware implementation of the neural network 50.

The parameters of refractory period R_{T}, leakage type and leakage rate are the parameters characterising two physical time mechanisms of a spike neuron.

The first mechanism is characterised by the refractory period R_{T}, which is the interval during which the neuron does not function after spiking.

In other words, if the neuron spiked at an instant t0, no incident spike is added to its membrane voltage until the later time t₀+R_{T}.

Such a mechanism reduces the number of output spikes of a neuron by limiting the frequency of the output neurons. With such a mechanism, the projection rate increases and unnecessary data redundancy is reduced.

By definition, the projection rate is the ratio of the number of spikes output from the projection unit 34 to the number of spikes input to the projection unit 34.

A compromise has to be found for the R_{T} refractory period between a time interval that is too short and would render the first mechanism useless, and a time interval that is too long and would result in too much information loss.

Alternatively, the first mechanism is implemented by allowing the addition to the membrane voltage but prohibiting spiking as long as the time since the generating of the previous spike is less than the refractory period R_{T}, even if the condition relating to the measured light intensity is met.

The second physical mechanism is a phenomenon of temporal decoherence, usually referred to as leakage.

The leakage mechanism is applied to the membrane potential which will therefore decrease with time in the absence of incident spikes.

The leakage type is the type of mathematical function that models the temporal decay of the membrane potential.

For example, such a decay is modelled by a linear function or an exponential function.

In the case of a linear function, the voltage decay is written as follows:

V(t)=Vᵢₘₚ(1−α(t−tᵢₘₚ))

where:
Vᵢₘₚ the membrane potential when the last spike is received,
tᵢₘₚ the instant when the last spike was received, and
α a constant.

In such a case, the leakage rate can be expressed as the time constant a which characterises the speed of the temporal decay of the membrane potential.

In the case of an exponential function, the voltage decay is written as follows:

$$V ( t ) = {V}_{imp} \cdot {e}^{- \frac{t - {t}_{i m p}}{τ}}$$

where:
Vᵢₘₚ the membrane potential when the last spike is received,
tᵢₘₚ the instant when the last spike was received, and
τ a constant.

In such a case, the leakage rate can be expressed as the time constant -u which characterises the speed of the temporal decay of the membrane potential.

In general, the leakage rate is, according to the example described, the time constant of the function type.

The second mechanism is therefore characterised by the type of function and the leakage rate.

The second mechanism allows the retention of time information to compensate for the apparent loss of information. For example, without the existence of the leakage mechanism, it is impossible to distinguish between a first case of a neuron activation generated by two temporally close (and therefore a priori temporally correlated) spikes and a second case with two of the same spikes temporally spaced by one hour (a priori temporally uncorrelated).

The neural network 50 is thus characterised by a set of parameters formed by all the parameters just described.

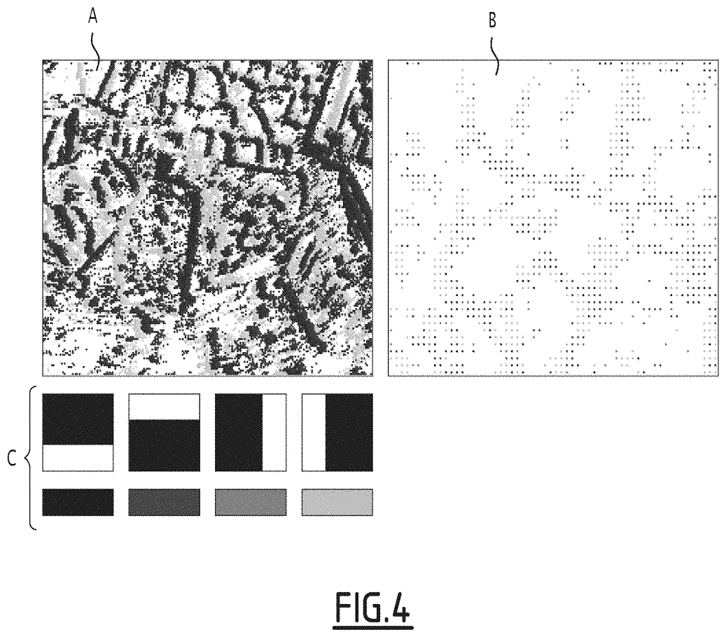

Examples of such parameters and their influence on the operation of the projection unit 34 will be described later with reference to the simulations in FIGS. 4 to 8.

More specifically, in the example described, the parameters of the projection unit 34 are chosen to maximise the projection rate while minimising the loss of spatial and temporal information contained in the input data to this unit under the constraint that the number of operations to be performed remains compatible with the computational capabilities of the observation system 10.

The parameters of the projection unit 34 parameter set most involved in the projection rate are the stride s between receptive fields, the number Nₖ of convolution kernels per neuron 54 and the refractory period R_{T}.

Depending on the parameters chosen, the applicant has obtained by simulation a projection rate between 1.5 and 100, more specifically between 5 and 15.

This results in a projected event stream F2.

The projection unit 34 is also suitable for time-stamping the output spikes.

Such a time stamp is to be made on the basis of the time at which the corresponding input spike was generated.

For example, an output spike may be time-stamped to the time of generation of an input spike that resulted in activation of a neuron 52.

According to another example, the output spike is time-stamped at any time of generation of an input spike among the plurality of input spikes that resulted in activation of a neuron 52. By definition, the plurality of spikes can be considered to be the set of spikes that arrived between the last instant in which the membrane potential has a zero value and the instant of activation of the neuron 52.

In other words, the moment characteristic of the projected event is a moment obtained by applying a function to the set of moments at which a neuron of the neural network has received an activation, or a moment obtained by applying a function to at least one moment when an initial event was generated from the set of initial events with which the projected event is associated.

This ensures that good timing accuracy is maintained, thus ensuring good synchronisation between the output spikes and the motion data from the event-driven sensor 12.

The output of the projection unit 34 is connected to the input of the compensation unit 36 as indicated by arrow 38 in FIG. 1.

As also visible in FIG. 1 below arrow 38, the output of the projection unit 34 is a projected event stream F2, each event of which is a spike characterised by a quadruplet (B1, B2, B3, B4).

This notation shows that the projection step is a projection step in which the information contained in the initial event stream F1, and more precisely in the deleted events, is transformed into other information. The loss of information related to the projection unit 34 is very low although the projection rate is relatively high (up to 15 depending on the parameters of the neural network 50).

In other words, the projection step increases the entropy of the events to compensate for the events removed from the initial event stream F1.

The compensation unit 36 is a compensation unit for the movement of the event camera 12 in the initial event stream F1.

In this sense, the compensation unit 36 is configured to implement a step of the compensation method, namely a step of compensating for the movement of the event camera 12 in the initial event stream F1.

The compensation unit 36 is therefore sometimes referred to as an EMC unit, with the acronym EMC referring to the term “ego-motion compensation”.

The compensation unit 36 takes as input the projected event stream F2, each event of which is a spike characterised by a quadruplet (B1, B2, B3, B4).

The compensation unit 36 is adapted to receive measurements of the movement of the event-driven sensor 12 during the observation time interval.

More specifically, the compensation unit 36 receives the movement data of the event-driven sensor 12 from the movement measurement unit 14 which are, in the example described, the rotation matrix R and the translation matrix T.

The compensation unit 36 is also adapted to apply a compensation technique to the projected event stream F2 according to the received measurements to obtain a compensated event stream F3 within the observation time interval.

In the example shown in FIG. 1, the compensation technique involves a process of cancelling the distortion introduced by the collection optic 23 followed by an operation of compensating for the movement of the event-driven sensor 12.

During the cancellation operation, the first information field A2 relating to the position of a pixel is modified by taking the distortion into account.

It should be noted that the cancellation operation can be replaced or supplemented by an operation of partial compensation of the optical aberrations introduced by the collection optics 23.

The compensation operation corrects the position of the spikes corrected by the cancellation operation according to the movements of the event-driven sensor 12.

The compensation operation allows the number of spikes emitted to be minimised.

With the movement of the event-driven sensor 12, individual pixels 20 generate spikes even in the presence of a stationary object. The compensation operation allows these different spikes to not be repeated and to be assigned to the same pixel 20 (or alternatively to the same set of pixels 20 if the object is extended).

Thus, the amount of spikes emitted by the event-driven sensor 12 is greatly reduced by the compensation unit 36.

For example, the motion compensation operation of the event-driven sensor 12 involves the implementation of two successive sub-operations for each spike.

In the first sub-operation, the value of the rotationmatrix R and the translation matrix T at the time of spike generation is determined. Such a determination is, for example, implemented by an interpolation, in particular between the rotation matrix R and the translation matrix T closest to the moment of spike generation.

The second sub-operation then consists of multiplying the coordinates obtained at the output of the first operation with the rotation matrix R and then adding the translation matrix T to obtain the coordinates of the spike after taking into account the ego motion of the event-driven sensor 12.

In another embodiment, the compensation technique is a machine learning algorithm.

For example, the algorithm is a neural network.

As seen in FIG. 1 below an arrow 46 representing the output of the compensation device 16 is a compensated event stream F3 each event of which is a spike characterised by a quadruplet (C1, C2, C3, C4)

The compensation technique used preserves the nature of the information fields. The first information field C1 is thus spatial information, the second information field C2 is time information, the third information field C3 is a value related to an initial event and the fourth information field C4 is a value related to a projected event.

The operation of the observation system 10 is now described with reference to FIGS. 4 to 8, which are examples of simulated event flows obtained at the output of the projection unit 34 and the compensation unit 36. FIGS. 4 to 7 schematically show the effect of the projection unit 34 on an initial event stream F1.

For this purpose, the initial event stream F1 is shown on the left as a greyscale image (part A of FIGS. 4 to 7). The darkest grey level (255) corresponds to a negative polarity, the lightest grey level (0) to a positive polarity.

The colour gradient is used to illustrate the passage of time, with one point becoming closer to the middle grey (128) as time passes.

A different representation is chosen on the right (part B of FIGS. 4 to 7) for the projected event stream F2. This is represented as greyscale-coded dots to show that these are projected events (coded on 4 elements in the example described) and not simple events (coded on 3 elements in the example described).

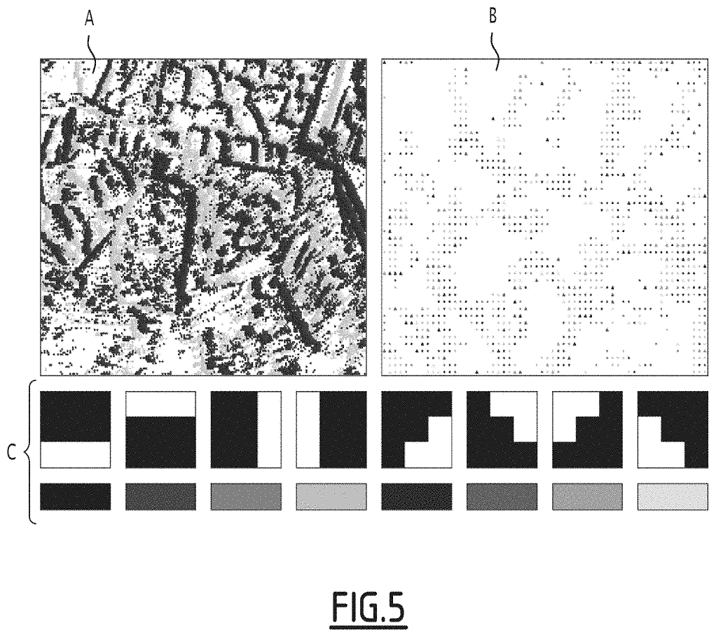

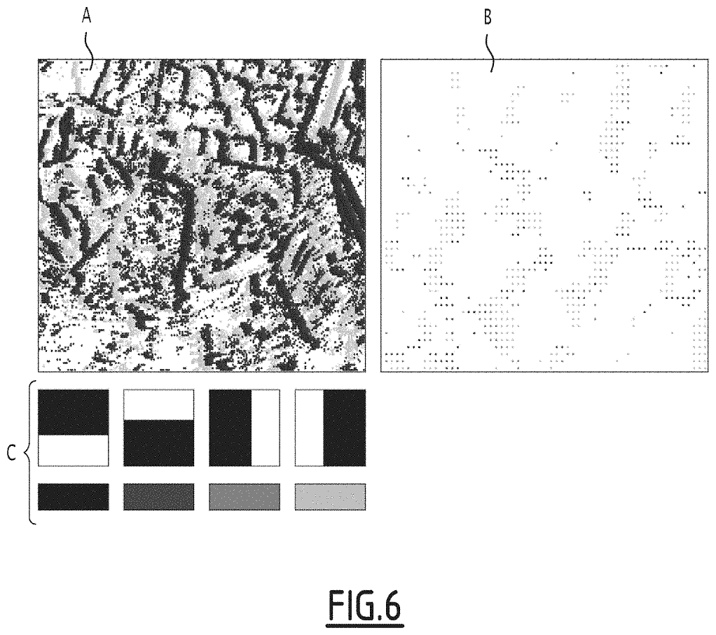

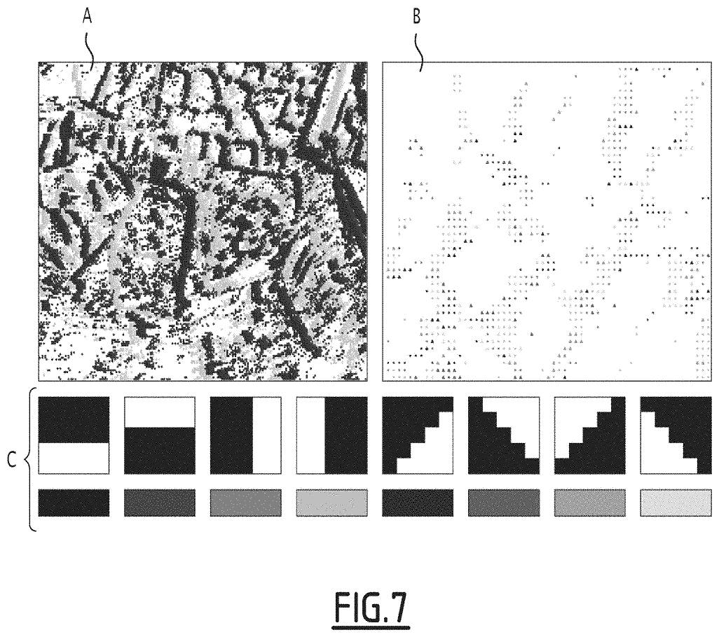

For the projected event stream F2, the greyscale coding is different since the coding is done on four levels (as in FIGS. 4 and 6) or eight levels (as in FIGS. 5 and 7) only, each level corresponding to a respective convolution kernel.

The pattern of each respective convolution kernel is visible in part C of each of FIGS. 4 to 7, the first four patterns being a line (for all figures) and the next four patterns where they exist being a staircase (starting from a different corner respectively). In the case of FIG. 5, the staircase has three steps, whereas in the case of FIG. 7 it has five.

Each of FIGS. 4 to 7 also vary in the set of parameters used for the projection unit 34 and more specifically only in the size of the W_{RF} receptive fields, the voltage threshold V_{S} and the number of kernels per neuron Nₖ.

In each case, the receptive field stride s is set to 2 pixels, the refractory period R_{T} is 5 milliseconds (ms), the leakage type is exponential and the leakage rate is 10 ms.

In the case of FIG. 4, the size of the receptive fields W_{RF} is equal to 3 pixels and the voltage threshold V_{S} is set to 3, the number of kernels per neuron Nₖ is equal to 4. The resulting projection rate is then 7.

A comparison of parts A and B of FIG. 4 shows visually that the number of events is greatly reduced in the case of the projected event stream F2.

In the case of FIG. 5, the size of the receptive fields W_{RF} is equal to 3 pixels and the voltage threshold V_{S} is set to 3, and the number of kernels per neuron Nₖ is equal to 8. The resulting projection rate is then 6.7.

Comparing FIG. 4 and FIG. 5 shows that the increase in the number of kernels per neuron visually increases as the amount of information increases in the projected event stream F2.

In the case of FIG. 6, the size of the receptive fields W_{RF} is equal to 5 pixels and the voltage threshold V_{S} is set to 9, and the number of kernels per neuron Nₖ is equal to 4. The resulting projection rate is then 12.4.

A comparison of FIG. 4 and FIG. 6 shows that the size of the receptive fields W_{RF} and the voltage threshold V_{S} are two parameters that strongly influence the projection rate.

In the case of FIG. 7, the size of the receptive fields W_{RF} is equal to 5 pixels and the voltage threshold V_{S} is set to 9, and the number of kernels per neuron Nₖ is equal to 8. The resulting projection rate is then 10.6.

Comparing FIG. 5 and FIG. 7 confirms that the size of the receptive fields W_{RF} and the voltage threshold V_{S} are two parameters that strongly influence the projection rate, even for a different number of kernels per neuron Nₖ.

In each case, a projection rate of the initial event stream F1 is obtained with a relatively small number of neural network operations 50.

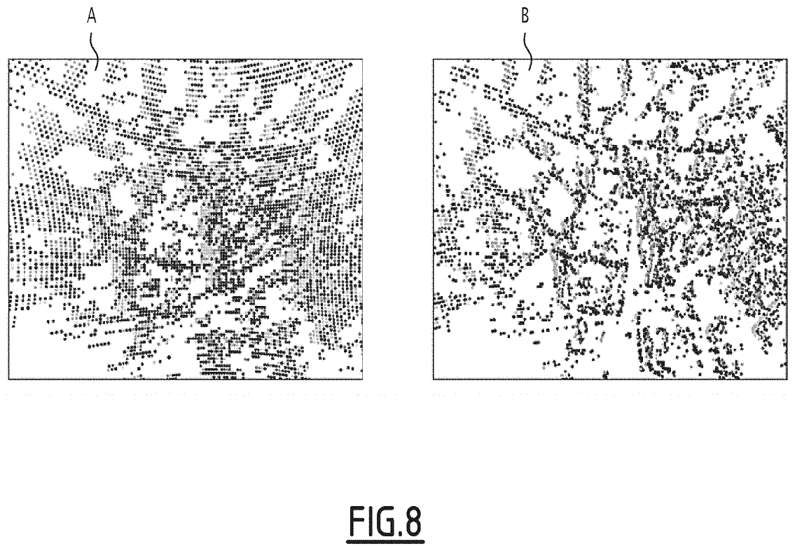

FIG. 8 shows graphically the effect of implementing the compensation step on a projected event stream F2 (left image) to obtain a compensated event stream F3 (right image).

The combination of a projection step and a compensation step thus provides a method for compensating for defects introduced by an event-driven sensor in an event stream generated during an observation of an environment that limits the required computational capacity.

This gain is made possible in particular by the fact that a high projection rate is obtained with the neural network 50 and by the use of an original format for representing a flow of events which limits information loss.

Due to the above advantages, such an observation system 10 is compatible with an embedded physical implementation.

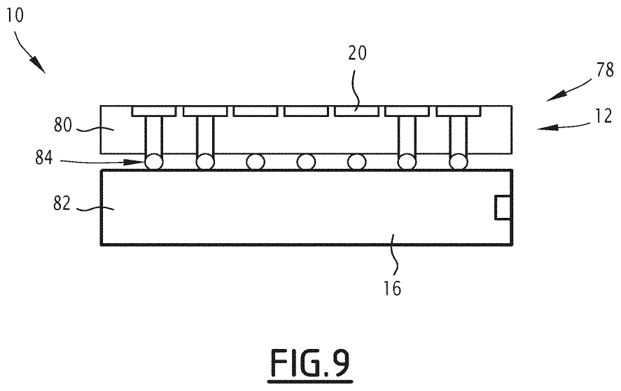

An example of such an implementation is now described with reference to FIG. 9.

In the example shown, the observation system 10 is a stack 78 of two layers 80 and 82 along a stacking direction.

The first layer 80 and the second layer 82 are superimposed.

The event-driven sensor 12 is manufactured in the first layer 80.

For this, a BSI technique is used, for example.

The acronym BSI refers to “Backside Illumination” and refers to a sensor manufacturing technique in which the pixel photodiodes 20 are positioned in direct contact with the collection optics 23.

In the second layer 82, the compensation device 16 is implemented under the pixel array 22.

This allows the read system 24 to be limited to simple connections since parallel access to each pixel 20 is allowed.

The second layer 82 is connected to the first layer 80 by three-dimensional copper-copper bonding 84. This type of bonding 84 is more often referred to as 3D bonding.

As regards the projection unit 34 and thus the physical implementation of the neural network 50, it is possible to use cores dedicated to the implementation of a part of the neural network 50 and to communicate with the other cores via the AER protocol. Such a core is more often referred to as a “cluster”.

When it is not possible to physically implement the projection unit 34 and the compensation unit 36 on the same layer 82 for space reasons, a third layer 86 is used.

The third layer 86 is part of the stack 78 and is superimposed with the first layer 80 and the second layer 82.

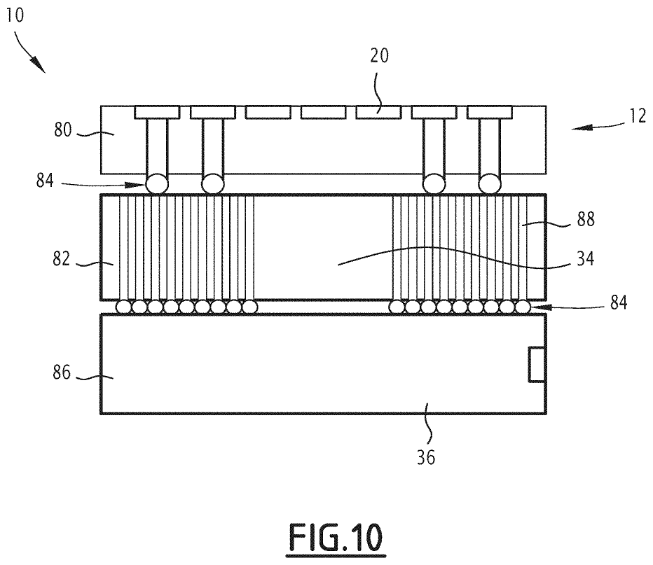

In such a configuration illustrated schematically in FIG. 10, the second layer 82 comprises the projection unit 34 while the third layer 86 comprises the compensation unit 36.

To ensure communication between the second layer 82 and the third layer 86, the second layer 82 is provided with through-holes 88.

A through-hole 88 is more commonly referred to as a “through-silicon via” and refers to an electrical contact extending along the stacking direction and being open, i.e. extending from one side of the second layer 82 to the other side of the second layer 82.

Such an implementation allows parallel communication between the second layer 82 and the third layer 86.

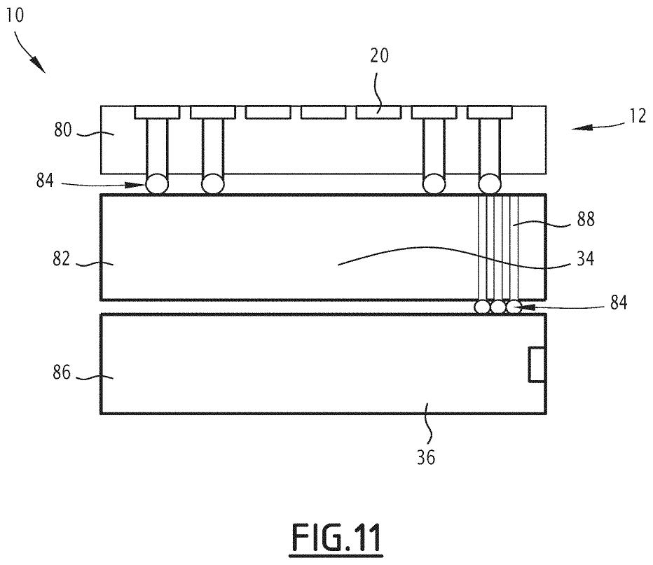

Alternatively, as shown in FIG. 11, communication between the second layer 82 and the third layer 86 is provided by a serial interconnect 90 involving the use of a data serialisation unit (not shown in FIG. 11) at the output of the projection unit 34.

Such an implementation is appropriate when the use of through-silicon vias 88 prevents the physical implementation of the projection unit 34. In effect, each through-silicon via 88 reduces the usable space, i.e. the space in which the compensation unit 34 can be manufactured, which may make it impossible to physically implement the projection unit 34 due to lack of space. In the implementation with a serial interconnect 90, on the other hand, the usable space is only slightly reduced, as illustrated by the comparison between FIGS. 10 and 11.

In each of the cases proposed in FIGS. 9 to 11, the event-driven sensor 12 and the compensation device 16 are part of the same stack 78 of at least two layers 80, 82 and 86, the first layer 80 of the stack 78 comprising the event-driven sensor 12, the at least one other layer 82 and possibly 86 of the stack 78 comprising the projection unit 34 and the compensation unit 36).

The observation system 10 thus physically implemented has the advantage of being a small embedded system.

Further embodiments of the observation system 10 are still possible.

For instance, the compensation unit 36 is implemented on a further component, the component and the compensation unit 36 being mounted on a substrate comprising electrical connections.

In one embodiment, the substrate is an interposer.

Alternatively or additionally, the observation system 10 comprises additional filtering which is implemented at the event-driven sensor 12.

The filtering is, for example, filtering by groups of pixels (typically 4). When a single pixel in a group of pixels generates an event that does not correlate with its neighbours, this event is considered as noise and therefore eliminated.

To improve such filtering, the group of pixels can, in some cases, be programmable according to rules.

In another embodiment, the event stream is represented not as a non-continuous, asynchronous stream of spikes but as a succession of hollow matrices, i.e. mainly empty matrices.

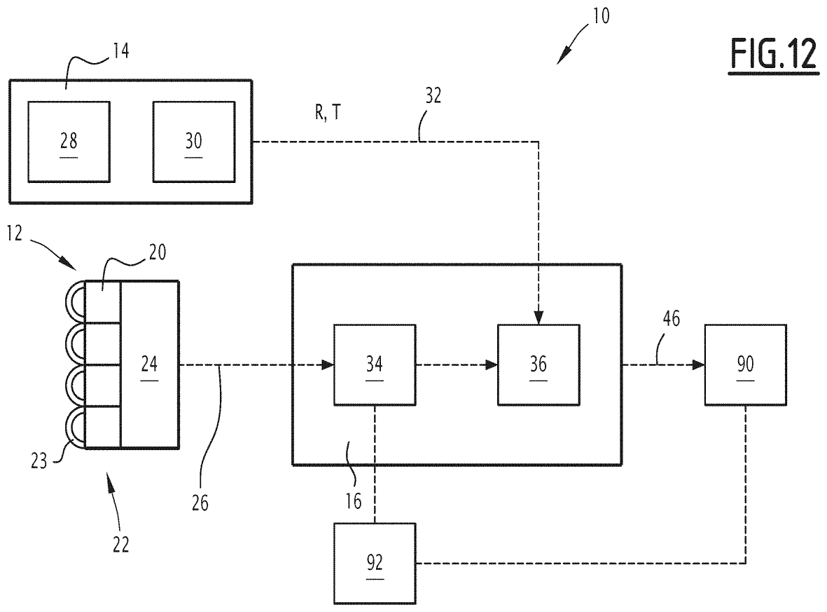

A further embodiment is shown with reference to FIG. 12.

In such a case, the observation system 10 further comprises a determination unit 92 and a modification unit 94.

The determination unit 92 is adapted to determine, for each projected event of the compensated event stream F 3, the mobile or stationary nature of an object associated with the enhanced event.

It is understood by the expression “object associated with the enriched event” that the object is the object imaged in the environment by the event-driven sensor 12 that caused the generation of the set of events to which the projected event belongs.

The edges of a stationary object appear with better contrast than those of a moving object.

Thus, for example, the determination unit 92 looks for the contrast value of the edges of each object, compares this value to a threshold and considers the object to be stationary only when the contrast value is greater than or equal to the threshold.

In another embodiment or in combination, the determination unit 92 uses the third information field C3. The modification unit 94 is adapted to modify parameters of the convolutional filter according to whether the object is moving or stationary, to obtain a modified convolutional filter.

For example, the voltage threshold V_{S} of each neuron 54 and the leakage rate are modified according to the nature of the object.

With the convolutional filter modified in this way, the compensation performed by the compensation device 16 is iterated.

More precisely, the projection step is again implemented by the projection unit 34 to obtain a new projected event stream F2.

The compensation unit 36 then compensates for the movement of the event-driven sensor 12 in the initial event stream F1 to obtain a compensated event stream F3.

This results in a compensated event stream F3 in which the movement of the event-driven sensor 12 is better compensated during the observation time interval.

Such an effect would also be obtained if the convolutional filter thus modified is applied to an initial event stream F1 generated at a time later than the observation time interval.

According to further embodiments, the determination of the mobile or stationary nature of the object is used by the modification unit 92 to modify other parts of the observation system 10.

In a first example, all events from certain pixels are eliminated because the imaged object is static. This reduces the amount of data to be processed.

According to a second example, assuming that the event stream is represented as a succession of hollow matrices as proposed above, the output frequency of the corrected hollow matrices at the output of the sub-second compensation unit 42 is reduced by decreasing the event generation frequency of the event-driven sensor. For example, the frequency chosen depends on the ratio of the number of stationary objects to the total number of objects imaged.

This reduces the amount of data to be processed.

It should be noted that there is nothing to prevent the determination unit 90 and a modification unit 92 from being physically implemented in the vicinity of the event-driven sensor 12, in particular in the third layer 86.

According to other embodiments corresponding in particular to applications in which the hardware implementation is less constrained, the neural network 50 that the projection unit 34 physically implements could comprise more layers of neurons 52 or a single fully connected layer of neurons 52.

In such a case, the physical implementation of the compensation device 16 is, for example, a computer implementation.

By way of illustration, an example of such an implementation is now described with reference to a computer.

The interaction of a computer program product with a computer enables the method of compensating for faults introduced by an event-driven sensor 12 into the initial event stream F1 to be implemented. The compensation method is thus a computer-implemented method.

More generally, the computer is an electronic computer capable of manipulating and/or transforming data represented as electronic or physical quantities in computer registers and/or memories into other similar data corresponding to physical data in memories, registers or other types of display, transmission or storage devices.

It should be noted that, in this description, the term “suitable for” means either “suitable for”, “adapted to” or “configured for”.

The computer has a processor with a data processing unit, memories and a media reader. Alternatively and additionally, the computer includes a keyboard and a display unit.

The computer program product contains a readable information medium.

A readable medium is a medium that can be read by the computer, usually by the reader. The readable medium is a medium adapted to store electronic instructions and capable of being coupled to a bus of a computer system.

For example, the readable medium is a floppy disk, optical disk, CD-ROM, magneto-optical disk, ROM, RAM, EPROM, EEPROM, magnetic card or optical card.

A computer program containing program instructions is stored on the readable information medium.

The computer program is loadable on the data processing unit and is adapted to drive the implementation of the compensation method.

In each of the above embodiments, which may be combined with each other to form new embodiments where technically feasible, a device or method is provided for compensating for the movement of the event-driven sensor in an event stream generated during an observation of an environment that reduces the computational capacity required to enable a physical implementation in an embedded system while retaining the useful information captured by the event-driven sensor.

Such a device or method is therefore particularly suitable for any application related to embedded vision. These applications include, but are not limited to, surveillance, augmented reality, virtual reality or vision systems for autonomous vehicles or drones.

1. A compensation device for compensating the movement of an event-driven sensor in an event stream generated within a time interval, called the initial event stream, the initial event stream being generated by the event-driven sensor upon observation of an environment in the time interval, the event-driven sensor comprising:
pixels, each pixel being adapted to generate an initial event of the initial event stream, and
a reader unit, the reader unit being adapted to generate information representing each initial event in the form of a first plurality of information fields in a first space, the first plurality of information fields comprising:
a first information field corresponding to the address of the pixel that generated the initial event and
a second information field corresponding to the time of generation of the event by the pixel that generated the initial event,
the compensation device comprising:
a projection unit, the projection unit being adapted to:
project the initial event stream from the first space to a second space using a projection function to obtain a projected event stream, the projected event stream being a set of projected events, each projected event being associated with a set of initial events from a respective pixel group,
the projection unit projecting the initial event stream into the second space so that a ratio of the number of initial events in the initial event stream to the number of projected events in the projected event stream is strictly superior to 1,
generate information representing each projected event as a plurality of information fields in the second space, the second plurality of information fields comprising:
a first information field corresponding to the address of a pixel associated with the projected event,
a second information field being a moment characteristic of the projected event, and
a third information field being a value relating to the set of initial events with which the projected event is associated, and
a compensation unit, the compensation unit being adapted to receive measurements of the movement of the event-driven sensor during the time interval, and adapted to apply a compensation technique to the projected event stream in dependence on the received measurements to obtain a compensated event stream in the time interval.

2. A compensation device according to claim 1, wherein the projection unit is a device implementing a neural network.

3. A compensation device according to claim 2, wherein the neural network comprises a single hidden layer.

4. A compensation device according to claim 2, wherein the projection function is a convolutional filter with a plurality of convolution kernels, each kernel being associated with a channel, the neural network thus being a spiking convolutional neural network, and wherein, for each projected event, the third information field comprises the channel identifier of the convolution kernel to which said projected event belongs.

5. A compensation device according to claim 4, wherein each convolution kernel is a set of receptive fields with an identical pattern, two successive receptive fields being separated by a stride, the number of convolution kernels, the stride and the size of the receptive fields being chosen so that the ratio of the number of initial events in the initial event stream to the number of projected events in the projected event stream is between 1.5 and 100.

6. A compensation device according to claim 2, wherein for each projected event the moment characteristic of the projected event is selected from the list consisting of:
a moment obtained by applying a function to the set of moments at which a neuron of the neural network has received an activation, and
a moment obtained by applying a function to at least one instant of generation of an initial event from the set of initial events with which the projected event is associated.

7. A compensation device according to claim 1, wherein the projection unit and the compensation unit are realised on the same integrated circuit.

8. A compensation device according to claim 1, wherein each spike is generated at a respective time, each plurality of information fields comprising an additional information field, the additional information field being the sign of the intensity gradient measured by the pixel at the time the spike was generated, the light intensity value at the time the spike was generated or the intensity gradient value measured by the pixel at the time the spike was generated.

9. A compensation device according to claim 1, wherein the compensation technique comprises applying at least one operation selected from:
a correction of the distortion introduced by a collection optic of the event-driven sensor,
a multiplication of the enriched event stream by a rotation matrix corresponding to the rotational movements of the event-driven sensor, and
an addition to the enriched event stream of a translation matrix corresponding to the translational movements of the event-driven sensor.

10. An observation system for an environment, the observation system comprising:
an event-driven sensor generating an event stream upon observation of the environment, the event-driven sensor comprising pixels and a reader unit, each pixel being adapted to generate an initial event of the initial event stream, the reader unit being adapted to generate information representing each initial event in the form of a plurality of information fields in a first space, characterised in that the first plurality of information fields comprising a first information field corresponding to the address of the pixel that generated the initial event and a second information field corresponding to the moment when the event was generated by the pixel that generated the initial event,
a measuring unit for measuring the movement of the event-driven sensor during a time interval, and
a compensation device according to claim 1.

11. An observation system according to claim 8, wherein the observation system further comprises:
a determination unit, the determination unit being adapted to determine, for each projected event of the compensated event stream, the mobile or stationary nature of an object associated with the projected event, the object being the object in the environment by the event-driven sensor that caused the generating of the set of events associated with the projected event, and
a modification unit, the modification unit being adapted to modify the projection function depending on whether the object is mobile or fixed.

12. An observation system according to claim 8, wherein the event-driven sensor and the compensation device are part of the same component comprising a stack of at least three layers, the first layer of the stack comprising the event-driven sensor, the second layer of the stack comprising the projection unit and the third layer comprising the compensation unit.

13. An observation system according to claim 8, wherein the compensation unit is provided on a further component, the component and the compensation unit being mounted on a substrate comprising electrical connections.

14. An observation system according to claim 13, wherein the substrate is an interposer.

15. A compensation method for compensating the movement of an event-driven sensor in an event stream generated within a time interval, called the initial event stream, the initial event stream being generated by the event-driven sensor upon observation of an environment in the time interval, the event-driven sensor comprising pixels and a reader unit, each pixel being adapted to generate an initial event of the initial event stream, the reader unit being adapted to generate information representing each initial event in the form of a first plurality of information fields in a first space, the first plurality of information fields comprising a first information field corresponding to the address of the pixel that generated the initial event and a second information field corresponding to the time of generation of the event by the pixel that generated the initial event, the compensation method being implemented by a compensation device for compensating for the movement of the event-driven sensor in an event stream generated within a time interval and comprising a step of:
projecting the initial event stream from the first space to a second space using a projection function to obtain a projected event stream, the projected event stream being a set of projected events, each projected event being associated with a set of initial events from a respective pixel group, the step of projecting comprising the generating of information representing each projected event as a plurality of information fields in the second space, the second plurality of information fields comprising a first information field corresponding to the address of a pixel associated with the projected event, a second information field being a moment characteristic of the projected event and a third information field being a value relating to the set of initial events with which the projected event is associated, and
a compensation step comprising applying a compensation technique to the projected event stream based on received measurements of the movement of the event-driven sensor during the time interval to obtain a compensated event stream in the time interval.
